(19) United States
(12) Patent Application Publication
(10) Pub. No.: US 2012/0158891 A1
(43) Pub. Date: Jun. 21, 2012

(54) TECHNIQUES FOR UNIVERSAL REPRESENTATION OF DIGITAL CONTENT

(75) Inventors: James Dooley, Bellevue, WA (US); Anshul Rawat, Kirkland, WA (US); Ketaki Deshpande, Redmond, WA (US); Jayashree Sadagopan, Redmond, WA (US); I-Ming Chen, Woodinville, WA (US); Daniel Oliver, Seattle, WA (US); Relja Ivanovic, Redmond, WA (US); Chris Guzak, Kirkland, WA (US)

(73) Assignee: MICROSOFT CORPORATION, Redmond, WA (US)

(21) Appl. No.: 12/974,609

(22) Filed: Dec. 21, 2010

(51) Int. Cl. G06F 15/16

(52) U.S. Cl. 709/217

(57) ABSTRACT

A universal content representation system (“UCRS”) implements techniques for universally representing digital content such as files, device information, and applications across a group of electronic devices that includes at least a source electronic device and a remote electronic device. Proxy content items, which correspond with items of content (“source content items”) stored on the source electronic device, are data stores for the corresponding source content items, and visually represent the corresponding source content items on the remote electronic device, whether the source electronic device is online or offline. A user of the remote electronic devices uses the proxy content items to search for and view source content items prior to requesting full access to the source content items. From time-to-time, source content items and proxy content items are synchronized with each other.

### BACKGROUND

Users of personal electronic devices such as personal computers, media players, personal digital assistants, and the like generally have digital content such as files, device information, and applications stored on each electronic device.

As a practical matter, users face a number of challenges discovering and using digital content stored on their own different devices. For example, it may be difficult for users to remember on which device digital content is stored, and there is little ability to search for remote digital content. Users also often experience problems discovering digital content on remote devices when such devices go to “sleep” or are otherwise offline. There are also performance issues where remote digital content may render very slowly, or have a different organization or appearance from locally stored digital content.

### SUMMARY

A universal content representation system (“UCRS”) and techniques for universally representing digital content such as files, device information, and applications across a group of electronic devices (such as personal computers, media players, personal digital assistants, video game consoles, home entertainment devices, in-cloud storage, and the like) configured for operation by a single user are discussed herein.

A group of electronic devices includes at least a source electronic device and a remote electronic device that are able to communicate via a network. Items of digital content stored on the source electronic device (referred to as “source content items”) are associated with corresponding representations of such content (referred to as “proxy content items”) stored on the remote electronic device. Proxy content items may also be stored on the source electronic device. Proxy content items enable the user of the remote electronic device to search for and view source content items prior to requesting full access to the source content items. From time-to-time, source content items and proxy content items are synchronized with each other in a peer-to-peer manner.

Proxy content items are data stores for corresponding source content items. The data stored is selected in such a manner that the proxy content items are generally smaller in size than their corresponding source content items. In one exemplary implementation, a proxy content item has a format that stores data used for three purposes: metadata for rendering a visual representation of the source content item on the remote electronic device; descriptive data about the source content item; and location information usable to access the source content item.

In one exemplary scenario, when a user of a remote electronic device locates a proxy item corresponding to a desired source content item (for example, via a user interface that enables searching for digital content on the remote electronic device and presenting search results), and tries to open or otherwise use such a proxy content item, the UCRS uses the location information in the proxy content item to access the source electronic device where the corresponding source content item is stored. If the source electronic device is accessible (for example, it is online on a network via which the devices can communicate, or it is asleep but able to be woken up via the network), then the source content item is retrieved, and it replaces the proxy content item on the remote electronic device. Otherwise, if the source electronic device is not accessible, the user may be notified and/or an error may be reported. Different versions of source content items (for example, versions with different fidelities) may be stored on the source electronic device, and proxy content items may refer to such different versions based on criteria such as the type of remote electronic device being used to access the source content items.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a simplified functional block diagram of an architecture via which digital content is universally represented and accessed by a group of electronic devices operated by a user.

FIG. 2 is a simplified functional block diagram of the universal content representation system (“UCRS”) shown in FIG. 1.

FIG. 3 is a flowchart illustrating certain aspects of a method for remotely accessing content on an electronic device, using the UCRS shown in FIG. 2.

FIG. 4 is another flowchart illustrating certain other aspects of a method for remotely accessing content on an electronic device, using the UCRS shown in FIG. 2.

FIG. 5 is a simplified functional block diagram of an exemplary configuration of an operating environment in which the UCRS shown in FIG. 2 and/or the methods shown in FIGS. 3 and 4 may be implemented or used.

### DETAILED DESCRIPTION

A universal content representation system (“UCRS”) implements techniques for accessing digital content stored on a source electronic device using a remote electronic device. The source and remote electronic devices are part of a group of electronic devices that are able to communicate via a network and are configured for operation by a user. Depending where the digital content being accessed is stored, a particular electronic device may function as either a source electronic device or a remote electronic device in different access transactions.

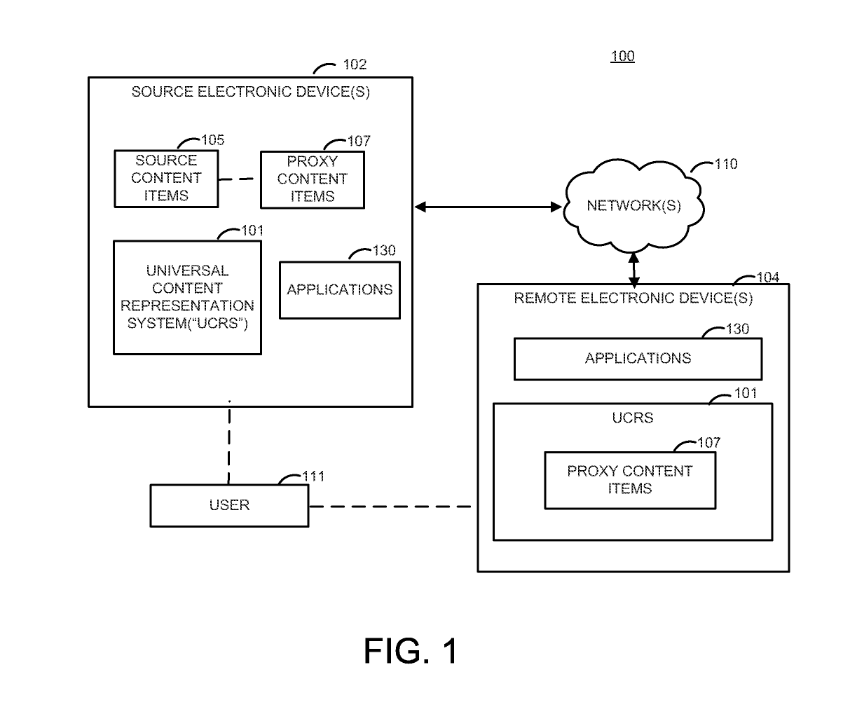

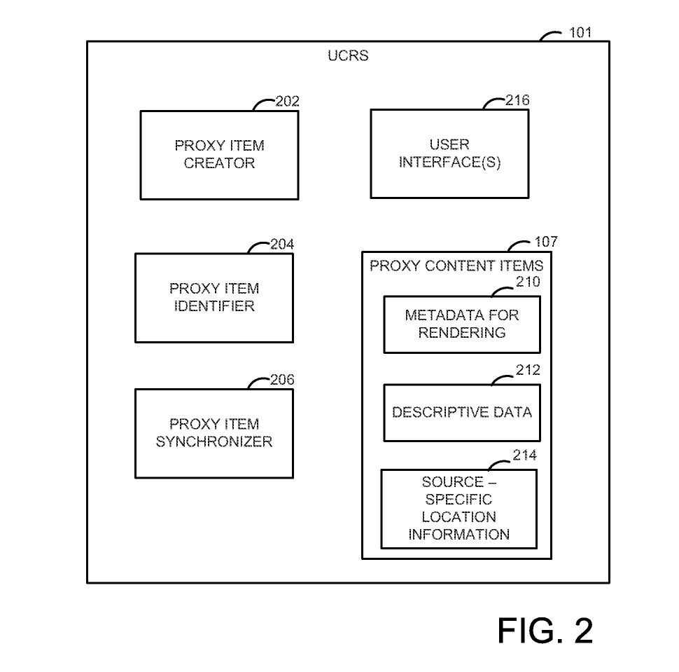

Turning now to the drawings, where like numerals designate like components, FIG. 1 is a simplified functional block diagram of an architecture 100, via which source content items 105 stored on source electronic device(s) 102 are universally represented and remotely accessed by a user 111 of remote electronic device(s) 104 via the use of proxy content items 107 stored on the remote electronic device(s) (and, as shown, optionally on the source electronic device(s)). As shown, both source electronic device(s) 102 and remote electronic device(s) 104 include UCRS 101 (discussed further below, in connection with FIG. 2), and it will be appreciated that aspects of UCRS 101 may also be present (though not shown) within network(s) 110.

Networks(s) 110 represent one or more local or wide-area, wired or wireless, packet- or circuit-switched, public or private, peer-to-peer or client-server based networks.

Source electronic device 102 and remote electronic device 104 represent any electronic device (or any physical or logical element of such an electronic device, either standing alone or included in other devices), which are configured for communication (via network(s) 110) with each other, and are operated by user 111. Examples of source and remote electronic devices include but are not limited to personal computers, personal digital assistants, phones, navigation devices, home entertainment devices, and the like.

User 111 is any person or entity authorized to operate a group of electronic devices that includes at least one source electronic device 102 and one remote electronic device 104.

Source content items 105 represent any item, in any format, stored on source electronic device(s) 102 in a digital format, including but not limited to: digital media files such as audio files, playlists, video files, image files, text files, document files, spreadsheet files, multimedia files, data files, and the like; metadata associated with digital media files; device information/metadata; and applications 130. Applications 130 represent end-user or system software used for any purpose. Metadata is any information, in any form or format, about source content items 105. It will be understood that source content items 105 may be protected by one or more enforceable intellectual property rights of one or more third parties. Any use of source content items 105 pursuant to techniques described herein is assumed to be in accordance with such intellectual property rights, and it will be understood that in some cases user 111 may be obligated to obtain license grants under such intellectual property rights, which license grants are beyond the scope of this document.

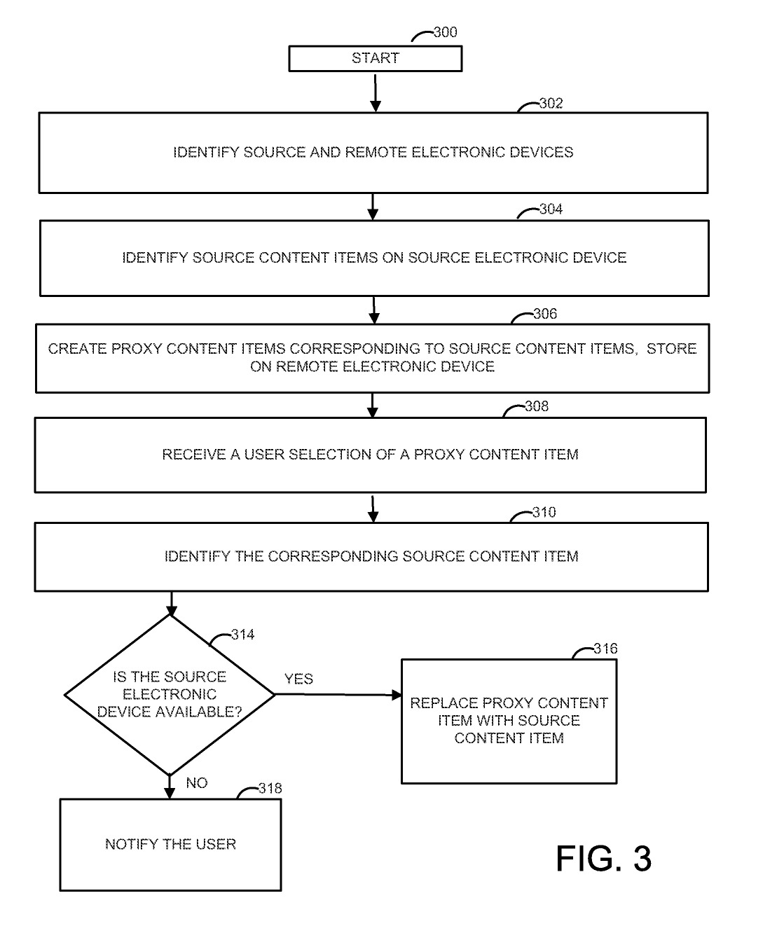

Proxy content items 107 (discussed farther below in connection with FIGS. 2 and 3) are data stores corresponding to source content items 105. Proxy content items 107 are used to display visual representations of corresponding source content items on remote electronic devices with access to the source content items, and to facilitate a user's ability to ubiquitously search for and browse content stored on a group of electronic devices operated by the user. The stored data is selected in such a manner that a particular proxy content item corresponding to a particular source content item may be smaller in size than the source content item, ensuring that it is faster to transport and consumes less storage space on an electronic device.

With continuing reference to FIG. 1, FIG. 2 is a simplified functional block diagram of UCRS 101. UCRS 101 is usable to facilitate the creation, distribution, location/searching and synchronization of groups of proxy content items 107 (which include metadata for rendering 210, descriptive data 212, and source-specific location information 214) between source and remote electronic devices 102, 104, UCRS 101 includes user interface(s) 216; proxy item creator 202; proxy item identifier 204; and proxy item synchronizer 206. In general, design choices and/or operating environments dictate how and whether specific functions of UCRS 101 are implemented. Such functions may be implemented using hardware, software, firmware, or combinations thereof.

User interface(s) 216 represents a combination of physical or logical displays and controls that define the way a user interacts with a particular device or application, such as source electronic device 102, remote electronic device 104, and application(s) (including UCRS 101). Displays are used to receive input from, or provide output to, a user. An example of a physical display is a monitor device. An example of a logical display is a data organization technique such as a window, a menu, or a layout thereof. Controls facilitate the receipt of input from a user. An example of a physical control is an input device such as a remote control, a display, a mouse, a pen, a stylus, a trackball, a keyboard, a microphone, or a scanning device. An example of a logical control is a data organization technique via which a user may issue commands. It will be appreciated that the same physical device or logical construct may function as an interface for both inputs to, and outputs from, a user.

Proxy item creator 202 is responsible for creating groups of proxy content items 107 corresponding to groups of source content items 105 on a particular source electronic device 104. Proxy content items are created (and edited, if desired) by source electronic devices and distributed to and stored on remote electronic devices. Proxy content items may also be stored on the same source electronic device as their corresponding source content items, and may or may not be visible to the user. There may or may not be a master copy of proxy content items maintained in a network location such as a central server. Generally, for each remote electronic device that will store a proxy content item corresponding to a source content item, there is one proxy content item. Proxy content items and source content items on a particular remote electronic device may be mutually exclusive from a user's perspective, that is, a user will only see either the proxy content item or the source content item, depending on the accessibility of the source electronic device (discussed further below).

Proxy content items are also generally presented in the same logical organizational framework (for example, folder structure and namespace), and with the same or similar experience, as their corresponding source content items. Proxy content items destined for different remote electronic devices, however, may differ in the versions (for example, different fidelities) of information provided regarding a particular source content item that is referenced thereby. In one possible implementation, this is accomplished by assigning different entity identifiers (not shown) to represent different fidelities/versions of the same source content item. The entity identifier may be recorded in the corresponding proxy content item, and read by the source electronic device when a remote electronic device requests the source content item via the proxy content item. Examples of different versions/fidelities of a proxy content item include but are not limited to: name only; name plus properties; name plus properties plus a thumbnail; and the full source content item. Generally, a particular proxy content item includes property information of its corresponding source content item, but not the source content item itself. When the actual source content item is fetched, as discussed further below, the proxy content item is replaced by the full source content item.

Proxy item creator 202 transcribes properties of source content items into a common format to generate proxy content items. The common format may be implemented using any appropriate encoding technique, such as XML. As shown, an exemplary common format includes a number of portions, into which data from the following categories is obtained and inserted: metadata 210 for rendering a visual representation of the corresponding source content item; descriptive data 212 about a particular source content item, which provides enough information to enable remote electronic devices to provide a discovery and browse scenario of proxy content items; and source-specific location information 214 usable to contact a specific source electronic device and access the corresponding source content item. Examples of metadata and descriptive data stored within proxy content items include but are not limited to: core data about a source content item; extended metadata (for example, the first 1000 characters in a file and the like); and rich thumbnails or icons.

Proxy item identifier 204 implements a browse feature for proxy content items, which if desired may also include search behavior, and is responsible for fetching/requesting source content items from source electronic devices when a user attempts to access (for example, open) a particular proxy content item, including determining accessibility of such source electronic devices. Source-specific location information 214 within the particular proxy content item is used to contact the source electronic device. The user is able to search/browse proxy content items, whether the source electronic devices are currently accessible via a particular network (referred to as being “online”) or not currently accessible via a particular network (referred to as being “offline”).

If the source machine is online (including being asleep but being able to be woken up), then the source content item is retrieved from it and replaces the proxy content item on the remote electronic device. Otherwise, the user is notified that the requested source content item is not available.

In one exemplary scenario, proxy item identifier 204 may also facilitate the ability to transfer different versions/fidelities of a source content item based on user-specified function or selection. For example, a user may identify a purpose or function to be performed on a file, or select from a list of available fidelities for the file, via a user interface associated with UCRS 101 (or an application 130), then the appropriate file fidelity can be retrieved (and control may be returned or granted to application 130, where applicable).

Proxy item synchronizer 206 is responsible for keeping proxy content items 107 in synchronization with corresponding source content items 105. When a source content item is edited, it is generally desirable to reflect the change in corresponding proxy content items. Any known or later developed synchronization solution or technique may be employed to perform synchronization operations. In one possible implementation, a proxy folder (not shown) may be created for every folder (or other logical organizational tool) on the source electronic device that is synchronized to a remote electronic device. A proxy folder may also be stored on the source electronic device. Generally, any electronic device that has readaccess to a source content item would have access to synchronization features, to track changes made to the item, to ensure that any change made to the source content item is reflected in its proxy content item and is picked up by the synchronization mechanism. Synchronization occurs from time-to-time and may be initiated manually by a user, or may be automatically performed/initiated by either the source electronic device or a remote electronic device. When a proxy folder is synchronized to multiple remote electronic devices, it is desirable to specify at what fidelity/version each of the remote electronic devices should synchronize corresponding source content items. In this case, an entity identifier may be chosen depending on the fidelity selected for each device.

APIs (not shown) may be available to applications 130 to leverage proxy-specific properties/functions and expose them to the extent needed to handle proxy items, or provide for custom features such as progress bars. For example, data provided in proxy content items may be easily usable by any application to retrieve source content items (for example data encoded using an XML schema that the application may parse without any additional requirements), or the application may be required to interact with UCRS 101 to retrieve source content items.

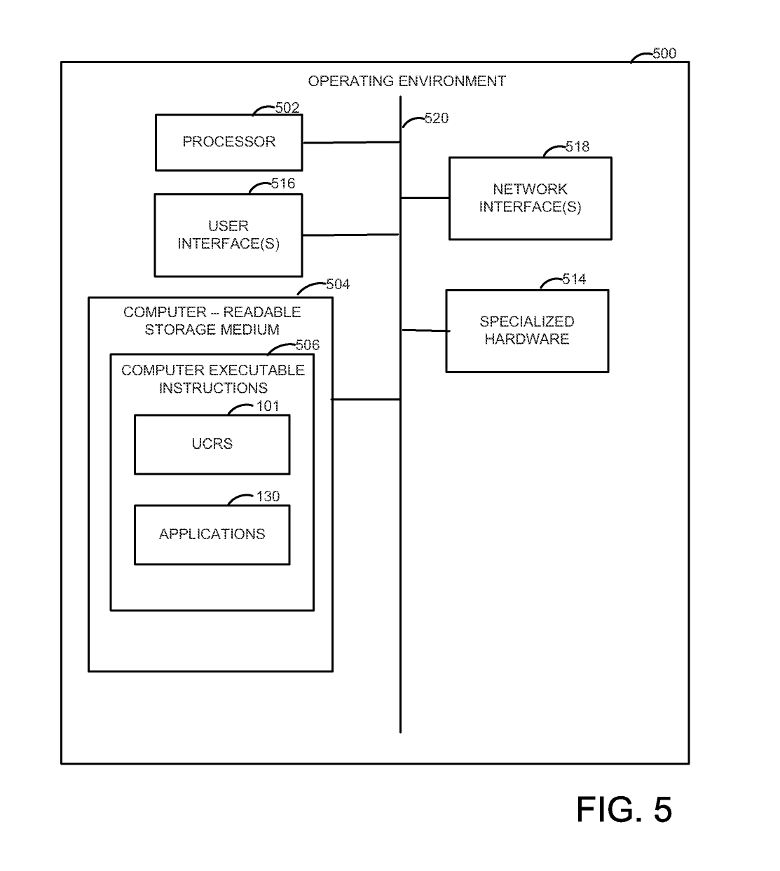

With continuing reference to FIGS. 1 and 2, FIG. 3 is a flowchart illustrating certain aspects of a method for remotely accessing content, such as source content items 105, stored on an electronic device, such as source electronic device 102, using a remote electronic device, such as remote electronic device 104, via UCRS 101. The method(s) illustrated in FIG. 3 may be implemented using computer-executable instructions executed by one or more general, multi-purpose, or single-purpose processors (exemplary computer-executable instructions 506 and processor 502 are discussed further below, in connection with FIG. 5). Unless specifically stated, the methods described herein are not constrained to a particular order or sequence. In addition, some of the described methods or elements thereof can occur or be performed concurrently. It will be understood that all of the steps shown need not occur in performance of the functions described herein.

The method begins at block 300, and continues at block 302, where a source electronic device and a remote electronic device are identified. A user's personal group of electronic devices may be defined in any known or later developed manner. It will be appreciated that in any given remote content access transaction, a particular electronic device may be either a source electronic device or a remote electronic device.

Next, at block 30z1, a group of source content items, such as source content items 105 (which are stored on the source electronic device) are identified, and at block 306, for each source content item in the group, a corresponding proxy content item, such as a proxy content item 107, is created and stored on the remote electronic device. A proxy content item is used to display a visual representation of the corresponding source content item on the remote electronic device.

Generally, proxy item creator 202 is responsible for creating proxy content items 107, by transcribing properties of source content items into a common format to generate proxy content items. Different versions of proxy content items (for example, versions with different fidelities) may be created (and stored on the remote electronic device and/or source electronic device) based on different criteria, such as the type of remote electronic device. It is also possible for the visual representation of the proxy content item to be different under different circumstances, such as whether the source electronic device is offline or online.

At block 308, a user selection of a particular proxy content item is received, and at block 310, the corresponding source content item is identified. Proxy item identifier 204 implements a search/browse feature that provides a user, such as user 111, the ability to search/browse proxy content items, whether source electronic devices are currently online (including being asleep but able to be woken up) or offline. In an exemplary scenario, a user interface enables searching for/browsing proxy content items on the remote electronic device and presenting the search results. Proxy item identifier 204 is also responsible for identifying and fetching/requesting source content items from source electronic devices when the user attempts to access (for example, open) a particular proxy content item, including determining accessibility of such source electronic devices. Generally, proxy item identifier 204 uses the location information in the proxy content item to access the source electronic device where the corresponding source content item is stored.

If as indicated at diamond 314, the source electronic device is accessible (for example, it is online on a network via which the devices can communicate, or it is asleep but able to be woken up via the network), then the source content item is retrieved, and as indicated, at block 316 it replaces the proxy content item on the remote electronic device. Otherwise, if the source electronic device is not accessible, as indicated at diamond 314, the user may be notified and/or an error may be reported, as provided at block 318. Any known or later developed push or pull technique (for example, copying or streaming) may be used to transfer the source content item to the remote electronic device.

In the case where an application, such as application 130, is being used to access/open a particular proxy content item, UCRS 101 (proxy item identifier 204) would generally first fetch the corresponding source content item, then return control to the application. UCRS 101 may optionally provide the application with a progress bar and/or API that could be used to acknowledge the user's actions. It is also generally desirable for UCRS 101 to display clear and concise error messages (for example, when source content items cannot be retrieved) and/or next steps to the user.

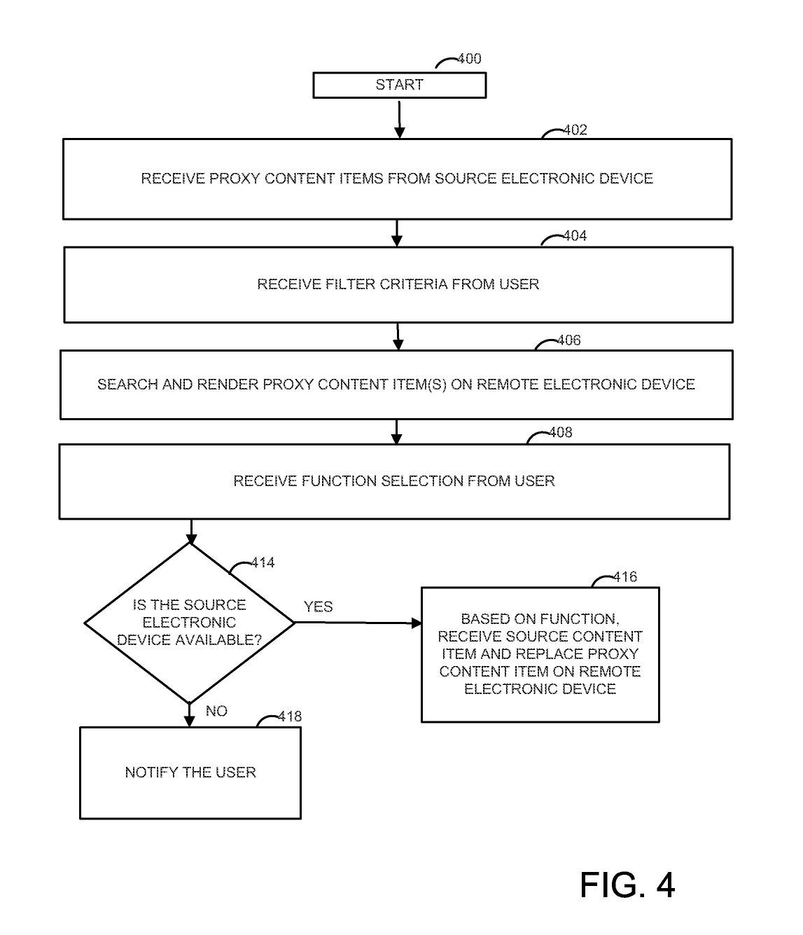

With continuing reference to FIGS. 1 and 2, FIG. 4 is a flowchart illustrating certain aspects of another method for remotely accessing content, such as source content items 105, stored on an electronic device, such as source electronic device 102, using a remote electronic device, such as remote electronic device 104, via UCRS 101. The method(s) illustrated in FIG. 4 may be implemented using computer-executable instructions executed by one or more general, multi-purpose, or single-purpose processors (exemplary computer-executable instructions 506 and processor 502 are discussed further below, in connection with FIG. 5). Unless specifically stated, the methods described herein are not constrained to a particular order or sequence. In addition, some of the described methods or elements thereof can occur or be performed concurrently. It will be understood that all of the steps shown need not occur in performance of the functions described, herein.

The method begins at block 400 and continues at block 402, where a group of proxy content items to be rendered on a remote electronic device are received. Next, at block 404, filter criteria are received, from a user, such as user 111. Filter criteria are generally search/browse criteria entered by user 111 via user interface(s) 216. Based on the filter criteria, proxy item identifier 204 may search descriptive data 212 to identify and render (via metadata for rendering 210) particular proxy content item(s) on the remote electronic device, as indicated at block 406. Next, at block 408, a function selection is received, from the user. In one exemplary scenario, the user may indicate to UCRS 101 or an application 130 the function such as editing or passively consuming) that he desires to perform on the source content item corresponding to the proxy content item identified at block 406.

If, as indicated at diamond 414, the source electronic device is accessible (for example, it is online on a network via which the devices can communicate, or it is asleep hut able to be woken up via, the network), then a version of the source content item is retrieved based on the selected function, and as indicated at block 416 it replaces the proxy content item on the remote electronic device. Otherwise, if the source electronic device is not accessible, as indicated at diamond 414, the user may be notified and/or an error may be reported, as provided at block 418. Any known or later developed push or pull technique (for example, copying or streaming) may be used, to transfer the source content item to the remote electronic device.

Thus, using flexible, extensible UCRS 101 and a common format for proxy content items 107, it is possible to ensure the consistent synchronization between source content items and proxy content items, and to enable ubiquitous, efficient, and customized discovery by users of content stored on a myriad of devices.

FIG. 5 is a simplified functional block diagram of an exemplary operating environment 500, with which aspects of UCRS 101 may be implemented or used. Operating environment 500 is indicative of a wide variety of general-purpose, special-purpose, client- or server-based, stand-alone or networked computing environments. Operating environment 500 may be, for example, a type of computer, such as a workstation, a server, a client-side electronic device, or any other type of stand-alone or networked computing device or component thereof now known or later developed. Operating environment 500 may also be a distributed computing network or Internet-based service, for example.

One or more components shown in FIG. 5 may be packaged together or separately to implement functions of operating environment 500 (in whole or in part) in a variety of ways. As shown, bus(es) 520 carries data, addresses, control signals and other information within, to, or from computing environment 500 or components thereof.

Network interface(s) 514 are one or more physical or logical elements that enhance the ability of operating environment 500 to receive information from, or transmit information to, another operating environment (not shown) via a communication medium. Examples of communication media include but are not limited to: wireless or wired signals; computer-readable storage media; computer-executable instructions; communication hardware or firmware; and communication protocols or techniques.

Specialized hardware 514 represents any hardware or firmware that implements functions of operating environment 500. Examples of specialized hardware 514 include encoder/decoders (“CODECs”), decrypters, application-specific integrated circuits, secure clocks, and the like.

A processor 502, which may be one or more real or virtual processors, controls functions of operating environment 500 by executing computer-executable instructions 506 (discussed further below).

Computer-readable storage media 504 represent any number and combination of non-transient, local or remote components, in any form, now known or later developed, capable of recording or storing computer-readable data, such as instructions 506 (discussed further below) executable by processor 502. In particular, non-transient computer-readable storage media 504 may be, or may include persistent memory or main memory, and may be in the form of: a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; or any combination thereof.

Computer-executable instructions 506 represent any signal processing methods or stored instructions that electronically control predetermined operations on data. In general, computer-executable instructions 506 are implemented as software programs according to well-known practices for component-based software development, and encoded in computer-readable media (such as one or more types of computer-readable storage media 504).

User interface(s) 516 (which may include user interface(s) 216) represent a combination of presentation tools and controls that define the way a user, such as a user of a client-side or peer electronic device, interacts with operating environment 500. One type of user interface is a graphical user interface (“GUI”), although any known or later developed type of user interface is possible. Presentation tools are used to receive input from, or provide output to, a user. An example of a physical presentation tool is a display such as a monitor device. An example of a logical presentation tool is a data organization technique (for example, a window, a menu, or a layout thereof). Controls facilitate the receipt of input from a user. An example of a physical control is an input device such as a remote control, a display, a mouse, a pen, a stylus, a trackball, a keyboard, a microphone, or a scanning device. An example of a logical control is a data organization technique (for example, a window, a menu, or a layout thereof) via which a user may issue commands. It will be appreciated that the same physical device or logical construct may function as an interface for both inputs to, and outputs from, a user.

Various aspects of an operating environment and an architecture/techniques that are used to implement aspects of UCRS. 101 have been described. It will be understood, however, that all of the described elements need not be used, nor must the elements, when used, be present concurrently. Elements described as being computer programs are not limited to implementation by any specific embodiments of computer programs, and rather are processes that convey or transform data, and may generally be implemented by, or executed in, hardware, software, firmware, or any combination thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A computer-readable storage medium encoded with computer-executable instructions which, when executed by a processor, perform a method for remotely accessing digital content on an electronic device, the method comprising:
identifying a group of electronic devices configured for operation by a single user, the group comprising at least a source electronic device and a remote electronic device, the source electronic device and the remote electronic device able to communicate via a network;
identifying a group of source content items stored on the source electronic device;
for each source content item in the group, creating a corresponding proxy content item to form a group of proxy content items, each proxy content item for displaying a visual representation of the corresponding source content item on the remote electronic device;
receiving a user selection, initiated at the remote electronic device, of a particular proxy content item;
based on the particular proxy content item, identifying a particular corresponding source content item;
determining if the source electronic device is accessible;
when the source electronic device is accessible, replacing the particular proxy content item with the particular corresponding source content item; and
when the source electronic device is inaccessible, not replacing the particular proxy content item with the particular corresponding source content item.

2. The computer-readable storage medium according to claim 1, wherein identifying the group of source content items comprises identifying the source content items via the remote electronic device.

3. The computer-readable storage medium according to claim 1, wherein each proxy content item has a format storing metadata for rendering the visual representation of the corresponding source content item on the remote electronic device, storing descriptive data about the corresponding source content item, and storing location information usable to access the corresponding source content item on the source electronic device.

4. The computer-readable storage medium according to claim 3, wherein the metadata stored by the first portion of each proxy content item varies based on the type of the corresponding source content item.

5. The computer-readable storage medium according to claim 1, wherein for each source content item, the corresponding proxy content item rendered on the remote electronic device is a partial representation of the source content item.

6. The computer-readable storage medium according to claim 1, wherein for each source content item, the corresponding proxy content item is identically rendered on the remote electronic device.

7. The computer-readable storage medium according to claim 1, wherein the group of proxy content items are stored on the source electronic device and the remote electronic device.

8. The computer-readable storage medium according to claim 7, further comprising:
from time-to-time, synchronizing the group of source content items with the group of proxy content items on the source electronic device and the remote electronic device.

9. The computer-readable storage medium according to claim 1, wherein replacing the particular proxy content item with the corresponding source content item comprises retrieving the corresponding source content item from the source electronic device.

10. The computer-readable storage medium according to claim 1, wherein replacing the particular proxy content item with the corresponding source content item further comprises:
selecting a version of the source content item to transfer to the remote electronic device; and
transferring the selected version of the source content item to the remote electronic device.

11. The computer-readable storage medium according to claim 1, wherein receiving a user selection, initiated at the remote electronic device, of the particular proxy content item further comprises:
detecting when an application accesses the particular a proxy content item;
removing control from the application; and
when the source electronic device is accessible, replacing the particular proxy content item with the corresponding source content item prior to returning control to the application.

12. The computer-readable storage medium according to claim 1, wherein determining if the source electronic device is accessible further comprises:
determining if the source electronic device is asleep; and
when the source electronic device is asleep, waking the source electronic device up.

13. The computer-readable storage medium according to claim 1, further comprising:
when the source electronic device is not available, notifying the user that the corresponding source content item is unavailable.

14. The computer-readable storage medium according to claim 1, wherein when the source electronic device is accessible, the particular proxy content item is replaced with the particular corresponding source content item via a peer-to-peer communication network.

15. The computer-readable storage medium according to claim 1, wherein the source content items are selected from the group comprising: device information; applications; and files.

16. A computer-readable storage medium encoded with computer-executable instructions which, when executed by a processor, perform a method for remotely accessing digital content on an electronic device, the method comprising:
receiving from a source electronic device a group of proxy content items to be rendered on a remote electronic device, each proxy content item corresponding to a source content item stored on the source electronic device, each proxy content item storing metadata for rendering a visual representation of the corresponding source content item on the remote electronic device, storing descriptive data about the corresponding source content item, and storing location information usable to access the corresponding source content item on the source electronic device;
via a user interface, receiving from a user a selection of filter criteria;
based on the filter criteria, searching the descriptive data of the proxy content items in the group to identify a particular proxy content item;
rendering the representation of the particular proxy item on the remote electronic device;
via the user interface, receiving from a user a selection of a function to be performed on a particular source content item corresponding to the particular proxy content item;
determining if the source electronic device is accessible;
when the source electronic device is accessible, based on the selected function and the location information of the particular proxy content item, receiving a version of the particular source content item from the source electronic device; and
replacing the particular proxy content item with the particular corresponding source content item on the remote electronic device.

17. The computer-readable storage medium according to claim 16, wherein the function is selected from the group comprising: editing and viewing.

18. The computer-readable storage medium according to claim 16, wherein rendering the representation of the particular proxy item on the remote electronic device comprises overlaying the representation with availability information about the remote electronic device.

19. A system, comprising:
a computer-readable storage medium; and
a processor responsive to the computer-readable storage medium and to computer-executable instructions stored in the computer-readable storage medium, the computer-executable instructions executable by the processor to perform a method comprising:
identifying a group of electronic devices configured for operation by a single user, the group comprising at least a source electronic device and a remote electronic device, the source electronic device and the remote electronic device able to communicate via a network;
identifying a group of source content items stored on the source electronic device;
for each source content item in the group, creating a corresponding proxy content item to form a group of proxy content items, each proxy content item having a format storing metadata for rendering the visual representation of the corresponding source content item on the remote electronic device, storing descriptive data about the corresponding source content item, and storing location information usable to access the corresponding source content item on the source electronic device;
receiving a user selection, initiated at the remote electronic device, of a particular proxy content item;
based on the particular proxy content item, identifying a particular corresponding source content item;
determining if the source electronic device is accessible;
when the source electronic device is accessible, replacing the particular proxy content item with the particular corresponding source content item; and
when the source electronic device is inaccessible, not replacing the particular proxy content item with the particular corresponding source content item.

20. The system according to claim 20, wherein the system is selected from the group comprising: a network-side operating environment; and a client-side operating environment.
